(19) United States
(12) Patent Application Publication
(10) Pub. No.: US 2024/0193340 A1
(43) Pub. Date: Jun. 13, 2024

(54) METHOD AND SYSTEM FOR DESIGNING LAYOUT OF INTEGRATED CIRCUIT

(71) Applicant: Samsung Electronics Co., Ltd., Suwon-si (KR)

(72) Inventor: Sunghoon LEE, Suwon-si (KR)

(73) Assignee: Samsung Electronics Co., Ltd., Suwon-si (KR)

(21) Appl. No.: 18/535,160

(22) Filed: Dec. 11, 2023

(30) Foreign Application Priority Data
Dec. 13, 2022 (KR) 10-2022-0174179

(51) Int. Cl. G06F 30/392; G06F 30/394

(52) U.S. Cl. CPC G06F 30/392; G06F 30/394

(57) ABSTRACT

A method of designing a layout of an integrated circuit includes generating floorplan data by performing floorplan based on input data for the integrated circuit, searching for a path between a first point and a second point, which are specified, the searching based on the floorplan data, and positioning components of the layout based on a result of the searching. The searching for the path includes distinguishing based on the floorplan data a first region where routing is possible from a second region where the routing is not possible, receiving position data on the first point and the second point, and searching for a shortest path between the first point and the second point, on the first region.

### CROSS-REFERENCE TO RELATED APPLICATION

This application is based on and claims priority under 35 U.S.C. § 119 to Korean Patent Application No. 10-2022-0174179, filed on Dec. 13, 2022 in the Korean Intellectual Property Office, the disclosure of which is incorporated by reference herein in its entirety.

### BACKGROUND

Various example embodiments relate to a method of designing a layout of an integrated circuit, and more particularly, to a method of designing a layout by using wiring path search.

As semiconductor technology advances, the design of an integrated circuit becomes complicated, and a large number of elements are integrated in a circuit. As many elements are integrated in the circuit, wiring becomes complicated, and as a result, issues, such as design rule violation and/or timing violation, may occur.

In particular, as the degree of integration increases, lengths of paths connecting cells and/or ports may greatly affect design quality, which may lead to electrical performance quality variations. The lengths of wiring paths has a great influence on timing delay, or the like, but when the wiring paths are not arranged within a distance required by or expected by or sufficient for a user, there may be an issue of design quality deterioration.

### SUMMARY

Various example embodiments may provide method of designing a layout, in which by verifying at an early stage paths of wirings connecting elements of an integrated circuit, time and/or resources used for verification and circuit correction may decrease, and design quality may be improved by performing a shortest path search operation.

According to various example embodiments, there is provided a method of designing a layout of an integrated circuit including generating floorplan data by performing a floorplan operation based on input data for the integrated circuit, searching for a path between a first point and a second point, which are specified, based on the floorplan data, and positioning components of the layout based on a result of the searching. The searching for the path includes distinguishing a first region, where routing is possible, from a second region, where the routing is not possible, based on the floorplan data, receiving position data on the first point and the second point, and searching for a short path between the first point and the second point, in the first region.

Alternatively or additionally according to some example embodiments, there is provided a method of designing a layout of an integrated circuit including receiving physical data including physical information about the integrated circuit, for input data on the integrated circuit, distinguishing a first region where routing is possible from a second region where the routing is not possible, the distinguishing based on the physical data, receiving position information about a first point and a second point, which are specified, and searching for a short path between the first point and the second point, on the first region.

Alternatively or additionally according to some example embodiments, there is provided a system configured to design a semiconductor chip including a processor, and a memory connected to the processor and storing machine-readable commands that, when executed by the processor, cause the system to perform a wiring path search operation for designing the semiconductor chip, wherein, by using the commands, the processor is configured to receive physical information about design exchange format (DEF) data of the semiconductor chip and library exchange format (LEF) data of the semiconductor chip, the receiving based on the physical information, to distinguish a first region where routing is possible from a second region where the routing is impossible in the semiconductor chip, generate an array having a size corresponding to a size of the semiconductor chip, represent a first component group including components of the array corresponding to the first region and a second component group including components of the array corresponding to the second region, receive position information about a first point and a second point, which are specified, and search for a short path between the first point and the second point in the first component group.

### BRIEF DESCRIPTION OF THE DRAWINGS

Various example embodiments will be more clearly understood from the following detailed description taken in conjunction with the accompanying drawings in which:

FIG. 1 is a block diagram of an integrated circuit design system according to some example embodiments;

FIG. 2 is a flowchart of an integrated circuit design process according to some example embodiments;

FIG. 3 is a flowchart describing a shortest path search method according to some example embodiments;

FIG. 4 is a flowchart describing another path search method according to some example embodiments;

FIG. 5 is a diagram illustrating a process of classifying a region, where routing is possible, according to some example embodiments;

FIG. 6 is a diagram of a shortest path search method according to some example embodiments;

FIG. 7 is a diagram illustrating a process of generating an array, according to some example embodiments;

FIG. 8 is a diagram of a shortest path search method according to some example embodiments;

FIG. 9 is a flowchart of an integrated circuit layout design process according to some example embodiments;

FIG. 10 is a diagram describing cell arrangement adjustment for a shortest path search operation, according to some example embodiments; and

FIGS. 11A and 11B are diagrams describing port arrangement adjustment for a shortest path search operation, according to embodiments.

### DETAILED DESCRIPTION OF VARIOUS EXAMPLE EMBODIMENTS

Hereinafter, some example embodiments will be described in detail with reference to the accompanying drawings.

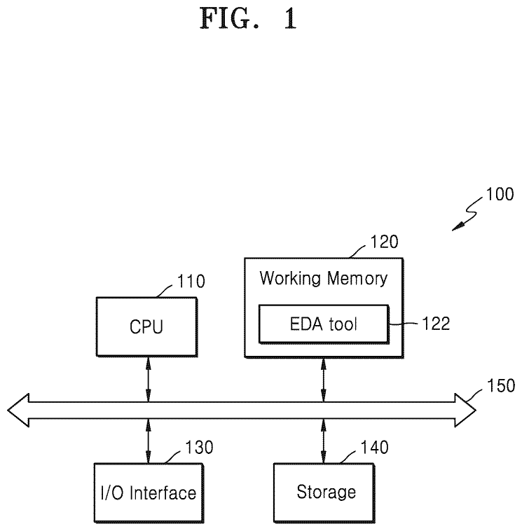

FIG. 1 is a block diagram of an integrated circuit design system 100 according to some example embodiments.

Referring to FIG. 1, the integrated circuit design system 100 may include a central processing unit (CPU) 110, which is an example of a processor, a working memory (or memory) 120, an input/output (I/O) interface 130, a storage (or a storage device) (hereinafter, referred to as a storage device) 140, and a system bus 150. The integrated circuit design system 100 may also be provided as a dedicated device for designing a semiconductor device, but may also include a computer for driving various design tools or arrangement tools.

The CPU 110 may execute software (e.g., one or more of application programs, operating systems, device drivers, or the like) to be executed in the integrated circuit design system 100. For example, the CPU 110 may execute an operating system (OS) loaded in the working memory 120. The CPU 110 may execute various application programs and/or design tools to be driven by the OS. For example, the CPU 110 may drive design tools of the semiconductor device loaded in the working memory 120. For example, an electronic design automation (EDA) tool 122 provided as a design tool may be driven by the CPU 110.

Either or both of the OS or application programs may be loaded in the working memory 120. At the time of booting the integrated circuit design system 100, an OS image stored in the storage device 140 may be loaded in the working memory 120 according to a booting sequence. All I/O operations of the integrated circuit design system 100 may be supported by the OS. Similarly, application programs (for example, the EDA tool 122) selected by a user or for providing basic service may be loaded in the working memory 120. The working memory 120 may include a volatile memory, such as one or more of static RAM (SRAM) and dynamic RAM (DRAM), and/or a non-volatile memory, such as one or more of phase change RAM (PRAM), magnetic RAM (MRAM), resistive RAM (ReRAM), ferro-electric RAM (FRAM), and a NOR flash memory.

The EDA tool 122 may generate a standard cell included in an integrated circuit. For example, the EDA tool 122 may store a library of the standard cell and/or may receive the library thereof from the outside. The standard cells may all have the same unit height; example embodiments are not necessarily limited thereto. The standard cells may have the same or different cell widths depending on the type thereof. The EDA tool 122 may use information about metal wirings used in a place and wiring or place and route (PNR) operation.

Alternatively or additionally, the EDA tool 122 may perform a floor plan according to a floor plan rule by using information about the standard cells included in the integrated circuit. For example, the floor planning operation may include creating a site-row and forming a metal routing track on the generated site-row. The site-row may be or may include or be included in a framework for arranging the standard cells used for designing a semiconductor device. The EDA tool 122 may generate a plurality of site-rows for designing a semiconductor device, and the site-rows may be generated with the same size and arranged adjacent to each other. The EDA tool 122 may perform a shortest path search operation according to some example embodiments, based on data on which the floor plan has been performed. Alternatively, the EDA tool 122 may perform the shortest path search operation according to some example embodiments, based only on physical information about a circuit (for example, design exchange format (DEF) data and library exchange format (LEF) data). A detailed description thereof is described below. The metal wiring track may include a virtual line in which metal wirings are formed in a subsequent process. In some example embodiments, in forming the metal wirings in this manner, wirings may be formed by arranging components of a layout according to a measurement result of the shortest path.

Alternatively or additionally, when performing the PNR operation, the EDA tool 122 may arrange the standard cells according to a layout designed based on the shortest path search method according to various example embodiments, and may connect metal wirings between each of the standard cells. For example, the EDA tool 122 may arrange the standard cells based on information about a semiconductor device that is generated based on the shortest path search method according to various example embodiments. Alternatively or additionally, the EDA tool 122 may connect spaces between the standard cells by forming the metal wirings along the metal wiring track by using a netlist of a semiconductor device.

The I/O interface 130 may control user inputs and/or outputs to and/or from user I/F devices. For example, the I/O interface 130 may include an input device, such as one or more of a keyboard, a mouse, and a touch pad, and may receive a netlist file of a semiconductor device and/or configuration information about various standard cells. Alternatively or additionally, the I/O interface 130 may be equipped with an output device, such as a monitor, and may display progress and processing results of the design operation of the integrated circuit design system 100.

The storage device 140 may be provided as a storage medium of the integrated circuit design system 100. The storage device 140 may store one or more of application programs, an OS image, and various data. The storage device 140 may also be provided as or include or be included in one or more of a memory card (a multi-media card (MMC), an embedded MMC (eMMC), a secure digital (SD) card, a MicroSD card, or the like) or a hard disk drive (HDD). The storage device 140 may include a NAND-type flash memory having a large storage capacity. Alternatively or additionally, the storage device 140 may also include a next generation non-volatile memory, such as one or more of PRAM, MRAM, ReRAM, FRAM, and a NOR flash memory.

The system bus 150 may be provided as an interconnector for providing a network inside the integrated circuit design system 100. The CPU 110, the working memory 120, the I/O interface 130, and the storage device 140 may be electrically connected to each other and interchange data via the system bus 150. However, a configuration of the system bus 150 is not limited thereto, and may further include coordination tools for an efficient management.

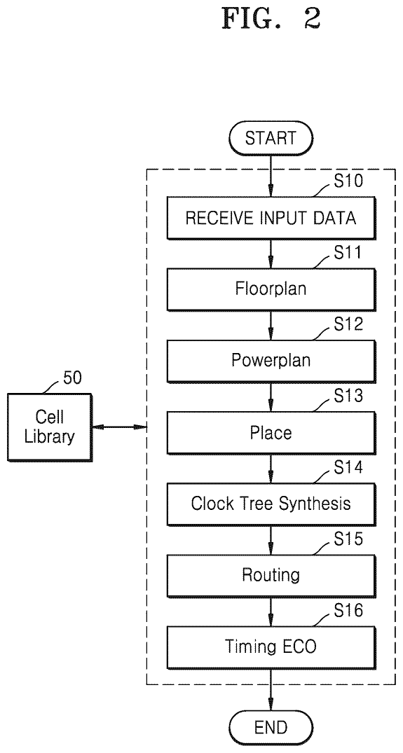

FIG. 2 is a flowchart of a design process of an integrated circuit, according to various example embodiments.

Referring to FIGS. 1 and 2, the design process of an integrated circuit may include an operation of designing a layout for an integrated circuit, and may be performed by the integrated circuit design system 100 described with reference to FIG. 1. The integrated circuit design system 100 may include a program including a plurality of instructions executed by a processor. Accordingly, the present design process may include a computer-implemented operation for designing an integrated circuit. The process of manufacturing a semiconductor element based on the layout designed as described above may be performed in a semiconductor process module.

An integrated circuit design process may include an input data receiving operation S10 in which information about the designed integrated circuit (for example, RTL data) is included, a floorplan operation S11 as described with reference to FIG. 1, a powerplan operation S12, a place operation S13, a clock tree synthesis (CTS) operation S14, a routing operation S15, and a timing engineering change order (ECO) operation S16. At least some of the operations in the integrated circuit design process may be performed based on the standard cells of a cell library 50.

The floorplan operation S11 may include an operation of physically designing a logically designed schematic circuit by cutting and moving the schematic circuit. For example, the floorplan may indicate or correspond to schematic arrangement information about gates in a block. The EDA tool 122 may use physical information about a circuit (for example, one or more of DEF, LEF, or the like) of the data used to perform the floorplan for the shortest path search operation according to various example embodiments. In the floorplan operation S11, memory and/or circuit functional blocks may be arranged. Likewise, the EDA tool 122 may search for a path such as a sufficiently short path, e.g., a shortest path, that may be routed by using location data such as the memory or circuit functional blocks, as described below in detail. In the floorplan operation S11, spaces for the circuit functional blocks may be allocated by, for example, identifying the circuit functional blocks to be arranged adjacent to each other, and considering available spaces, required performance, etc. For example, the floorplan operation S11 may include an operation of generating the site-row as described above and an operation of forming a routing track on the generated site-row. The site-row may include a tool for arranging the standard cells stored in the cell library 50 according to a prescribed design rule. The wiring track may provide a virtual line in which wirings are later formed. The wirings may be arranged on the wiring tracks in the subsequent wiring operation S15.

The powerplan operation S12 may include an operation of arranging patterns of wirings connecting local power sources, for example, a driving voltage and/or a ground voltage, to the arranged circuit functional blocks. For example, patterns of wirings connecting a power source and/or ground may be generated so that power may be evenly supplied to the entire chip in the form of a net. In the powerplan operation S12, the patterns may be generated in the form of a net by using various rules.

The place operation S13 may include an operation of arranging patterns of elements included in the circuit functional block, and may include an operation of arranging the standard cells from the cell library 50. In particular, in some example embodiments, each of the standard cells may be configured to correspond to the shortest wiring path searched for according to some example embodiments. Empty regions may occur between the standard cells, and the empty regions may be filled by filler cells. Unlike the standard cells, the filler cells may include dummy regions. In some example embodiments, the dummy regions may include patterns such as dummy patterns that help mitigate various process marginalities, such as chemical-mechanical planarization (CMP) process marginalities. According to the place operation S13, a shape and/or a size of a pattern for configuring transistors and wirings to be actually formed on a silicon substrate may be defined. For example, to form an inverter circuit and/or a NAND gate circuit on an actual silicon substrate, layout patterns for PMOS, NMOS, N-WELL, gate electrodes, and wirings to be arranged thereon may be appropriately arranged. In some example embodiments, even after the place operation S13 is performed, cells or the like may be rearranged to satisfy the shortest wiring path, based on the shortest path search method.

The clock tree synthesis (CTS) operation S14 may include an operation of generating patterns of signal lines of a center clock related to an operating speed for determining the performance of the semiconductor element.

The wiring operation S15 may include an operation of generating a wiring structure connecting the standard cells arranged as described above. The wiring structure may be electrically connected to wirings in the standard cells, and may electrically connect the standard cells to each other.

Thereafter, the results of the place, CTS, and wiring operations S13 through S15 may be verified. The timing ECO operation S16 may be performed. For example, the timing ECO operation S16 may include a static timing analysis (STA) operation and an update timing operation. For example, the timing ECO operation S16 may include a timing improvement or timing optimization operation. For verification, an operation of determining whether there is a timing violation may be included. For example, whether there is a setup time violation or a hold time violation of a flip-flop may be determined. Timing latency may be significantly affected by the wiring path, that is, the physical distance. Accordingly, by obtaining the shortest wiring path at an early stage according to various example embodiments, points causing a timing violation and/or timing latency may be identified at an early stage. By correcting the points at an early stage, design quality (for example, timing quality of result (QoR)) may be improved, and a turnaround time (TAT) may be improved. Alternatively or additionally, the total time required or used for the design may also be reduced. Likewise, even after the timing ECO operation S16 is performed, cells or the like may be rearranged to satisfy a target timing, based on the shortest path search method according to various example embodiments.

Thereafter, set, or preset, or dynamically determined physical design rule check (DRC) and correction may be performed. For example, the DRC may be performed based on the design rule stored in the storage device 140 in FIG. 1.

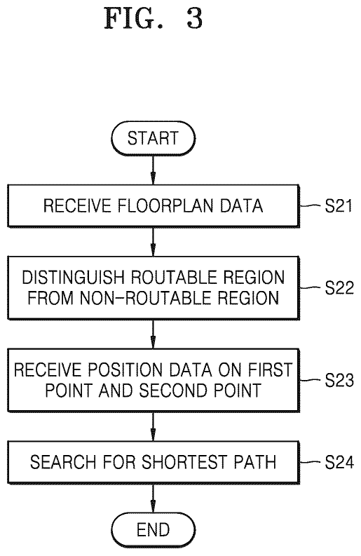

FIG. 3 is a flowchart of the shortest path search method according to various example embodiments.

Referring to FIGS. 1 through 3, the shortest path search method according to some example embodiments may include an operation S21 of receiving floorplan data, an operation S22 of distinguishing a routable region from a non-routable region, an operation S23 of receiving position data on a first point and a second point, and an operation S24 of searching for the shortest path.

As described above, when the floorplan is performed, an operation of physically designing the logically designed schematic circuit may be performed. In this case, the EDA tool 122 may receive the floorplan data that is a result of performing the floorplan (S21). For example, the floorplan data may include data on various blocks, data on I/O regions, and data on pieces of intellectual property (IP) and/or other standard cells. For example, the floorplan data may include information about positions and sizes of blocks, pieces of IP, etc. Alternatively or additionally, for example, data on a region for complying with a design rule may also be included. In this manner, data on regions occupied by the blocks and pieces of IP may be used to define regions, in which routing, that is, wiring, is impossible.

Accordingly, after receiving data on the floorplan, the EDA tool 122 may distinguish a routable region from a non-routable region based on the received data (S22). Thereafter, the EDA tool 122 may receive information about arbitrary points from the user (S23). For example, the user may specify two particular points to ensure that the cell or port or pin is arranged within a desired distance, and/or to place them at desired points.

The EDA tool 122 may receive location data on the two points (a first point and a second point), and search for the shortest path between the first point and the second point (S24). In searching for the shortest path, for example, one or more of an a-star (A*) algorithm, a jump point search algorithm, or the like, which are algorithms for searching for the shortest path, may be used. However, example embodiments are not limited thereto. For example, in addition to or in lieu of the algorithms described above, various methods may be used to search for the shortest path.

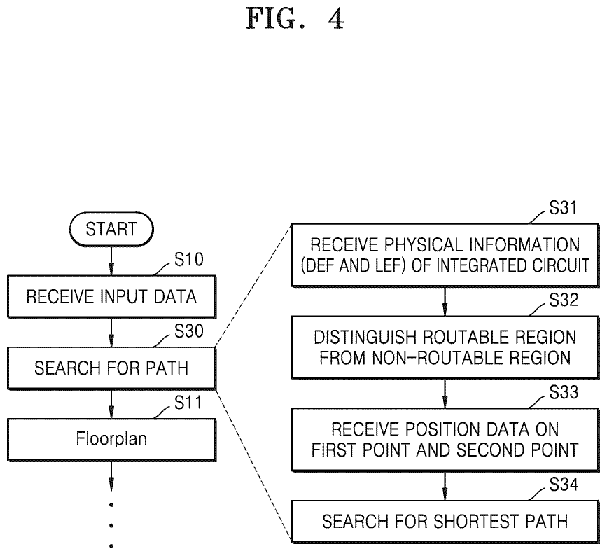

FIG. 4 is a flowchart describing the shortest path search method according to some example embodiments.

Referring to FIGS. 2 through 4, the EDA tool 122 may perform the shortest path search operation by using physical information about an integrated circuit. A routable region and a non-routable region in an integrated circuit may be distinguished by using only physical information about the integrated circuit. For example, even before the floorplan operation S11 is performed, the EDA tool 122 may receive data on the integrated circuit, and then, based on the received data, may perform distance measurement according to some example embodiments (S10 and S30).

The EDA tool 122 may receive data required or used for distinguishing a routable region, in the data on the integrated circuit. In some example embodiments, the EDA tool 122 may use only physical information (for example, the DEF and/or the LEF, or the like) from the data on the integrated circuit (S31). Because at least one purpose is to distinguish physical regions, even when there is no logical information (for example, a netlist or the like) about a logical connection of a circuit, it may be possible to distinguish non-routable regions based on the physical information (S32). For example, the EDA tool 122 may obtain information about a non-routable region by using DEF data, LEF data, or the like, for example, various blocks data, I/O region data, IP data, data on regions to comply with design rules, etc. In this manner, data on regions occupied by the blocks and pieces of IP may be used to define regions, in which routing, that is, wiring, is impossible.

Hereinafter, because operations S32 through S34 respectively correspond to operations S22 through S24 described above with reference to FIG. 3, descriptions thereof are omitted.

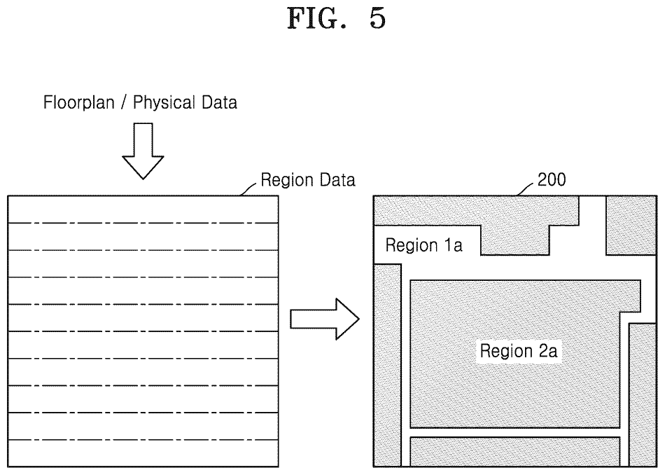

FIG. 5 is a diagram illustrating a process of distinguishing a routable region, according to some example embodiments.

Referring to FIGS. 1 and 3 through 5, the EDA tool 122 may distinguish regions based on the floorplan data or the physical information (for example, DEF data and/or LED data). In some example embodiments, the EDA tool 122 may generate region data representing the entire region of the integrated circuit according to the floorplan data or the physical data as described above. In addition, the EDA tool 122 may obtain data on the non-routable region from the floorplan data or the physical information (floorplan/physical data). For example, the EDA tool 122 may obtain data on regions occupied by one or more of various blocks, data on I/O areas, data on pieces of IP, or data on regions for complying with the design rules. However, the data used for distinguishing non-routable regions in example embodiments is not limited thereto. For example, the EDA tool 122 may obtain data on regions, in which arranging wirings is not possible, in addition to or in lieu of the examples described above, from the floorplan data or physical information (floorplan/physical data). The EDA tool 122 may generate, from the region data, first distinguished region data 200, that is distinguished into a 1a region Region 1a, which is routable, and a 2a region Region 2a, which is non-routable, according to the acquired data on the non-routable region.

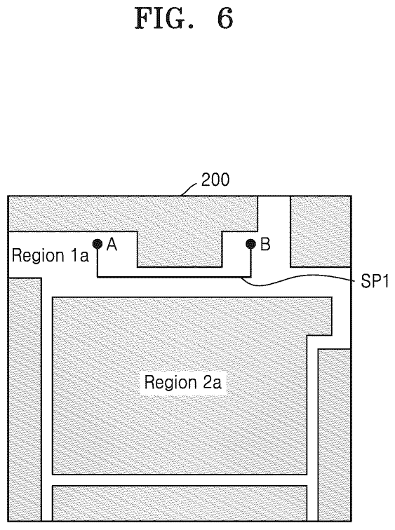

FIG. 6 is a diagram of the shortest path search method according to some example embodiments.

Referring to FIGS. 5 and 6, the EDA tool 122 may search for the shortest path between two particular points based on the first distinguished region data 200. For example, the EDA tool 122 may receive position data for a first point A and a second point B, which are specified externally, such as by a user. The shortest path may be the shortest path based on a taxicab or Manhattan distance metric; however, example embodiments are not limited thereto. The EDA tool 122 may specify two points as illustrated on the first distinguished region data 200 based on position data on the first point A and the second point B. Next, the EDA tool 122 may search for the shortest path (for example, a first shortest path SP1) connecting the first point A and the second point B, which are specified on the routable 1a region Region 1a. For example, either or both of the A* algorithm or a jump point search algorithm, which are algorithms for the shortest path search, may be used. However, example embodiments are not limited thereto. For example, in addition to or in lieu of the algorithms described above, various methods may be used to search for the shortest path.

In some example embodiments, the first point A and the second point B may include arbitrary positions of cells which are designated by a user to verify a path between arranged cells (or, designated by a user to specify desired positions of cells to be connected to each other). Alternatively or additionally, for example, the first point A and the second point B may include arbitrary positions of ports designated for routing between the ports. However, example embodiments are not limited thereto. For example, the first point A and/or the second point B may include points (for example, pin positions or the like) specified by the user to determine the shortest path between any two points. In this manner, the configurations of a desired layout at the first point A and the second point B specified by the user may be arranged, and the configurations may be routed based on the first shortest path SP1.

To increase the design quality (for example, timing quality), an adjustment, such as reduction in physical distance that significantly affects timing delay, may be required or desirable. As described above, in inventive concepts, because only physical information (for example, DEF data and/or LED data, or the like) is used to determine the routable region of the circuit without logical information (for example, information about logical connection, such as the netlist), the shortest path may be determined based on only the initial level data. As a result, by using the contents of inventive concepts, the components of the layout may be positioned by determining at an early stage arrangements of cells, ports, or the like within the desired distance of the user so that the target timing operation may be performed, and/or positions of the components may be adjusted by verifying at an early stage whether the cells, ports, or the like are arranged with in the desired distance. In this manner, by identifying points where the design rule violation and/or the timing violation occur, these phenomena may be prevented or reduced in likelihood of occurring at an early time point, and accordingly, the TAT and/or QoR may be improved. A photomask may be taped out and cut based on the design, and a device such as a semiconductor device and/or integrated circuit may then be fabricated based on the photomask.

Alternatively or additionally, when the wiring length is measured and determined after the place or routing operation is performed, because all of the place operation, the CTS operation, and the routing operation need to or are expected to be performed, the time and/or resource consumption thereof may be increased. In particular, as the size of the layout or chip increases, the performance time of the operations may increase significantly. Alternatively or additionally, because Synopsys design constraints (SDC) files or the like are required or are used for synthesis to measure by using the wiring length after the routing, additional time and resources to prepare for the measurement may be required or expected. However, because determination of the distance and timing by using the initial level data, and adjustment on the layout configuration thereof are possible, the inventive concept may effectively reduce the time and resources consumption, which may improve the manufacturability of the semiconductor device.

Alternatively or additionally, as described above in example embodiments, because the shortest path search and verification processes based on the initial level data are automated and performed, errors occurring while the shortest path search and verification processes are manually performed may be reduced to increase accuracy, and the time required for the verification process itself may also be reduced.

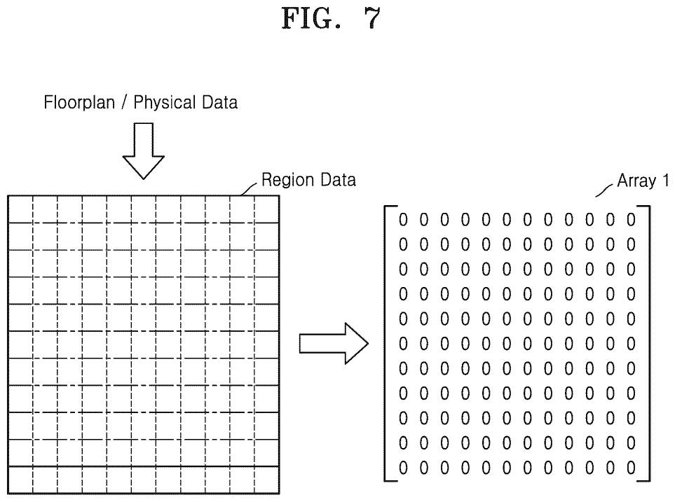

FIG. 7 is a diagram illustrating a process of generating an array, according to some example embodiments.

Referring to FIGS. 3 through 5 and 7, the EDA tool 122 may convert the entire region of a circuit into a first array Array 1. In some example embodiments, the EDA tool 122 may generate the region data based on the floorplan data or the aforementioned physical information (for example, DEF data and/or LEF data). The EDA tool 122 may divide the entire region of the layout by a unit area. The size of the unit area may be preset by an external control, and may have various magnitudes.

The EDA tool 122 may generate an array including components corresponding to each unit area. For example, as illustrated, the region data may be divided into regions of a certain size, and then, converted into the first array Array 1 having a size of 11×11 corresponding thereto (example embodiments are not limited to this size). The components of the first array Array 1 may respectively correspond to the regions having the certain size. In some example embodiments, components of the first array Array 1 are displayed as “0”, but are not limited thereto, and may be displayed in various characters.

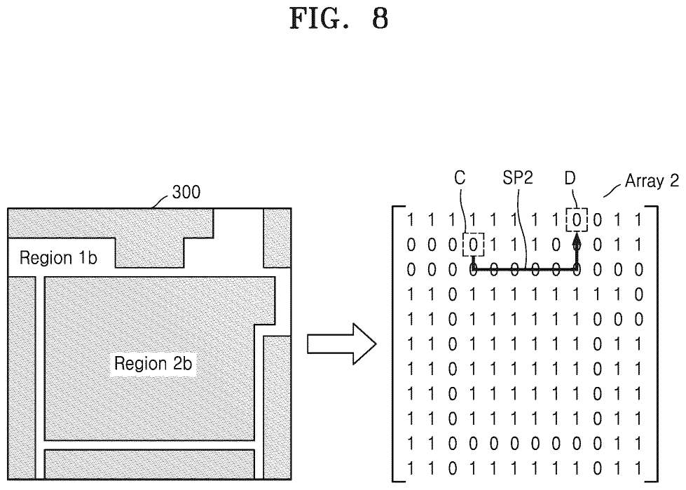

FIG. 8 is a diagram illustrating another shortest path search method according to some example embodiments.

Referring to FIGS. 5 through 8, the EDA tool 122 may search for the shortest path based on the converted array. In some example embodiments, as described above with reference to FIG. 5, the EDA tool 122 may generate second distinguished region data 300, in which a layout of a circuit is distinguished as a 1b region Region 1b, which is routable, and a 2b region Region 2b, which is non-routable, based on the floorplan data and/or on physical information (for example, DEF and/or LEF data).

Next, the EDA tool 122 may change components of the first array Array 1 based on the second distinguished region data 300. The second distinguished region data 300 may also be divided by a set or preset unit area as described above with reference to FIG. 7. Because the first array Array 1 is also divided by the unit area, components included in the first array Array 1 may correspond to respective unit areas of the second distinguished region data 300. Similarly, the 1b region Region 1b and the 2b region Region 2b included in the second distinguished region data 300 may also be divided based on the unit area. In this case, the EDA tool 122 may represent components of the first array Array 1 corresponding to the unit areas included in the 1b region Region 1b as 0. Similarly, the EDA tool 122 may represent components of the first array Array 1 corresponding to the unit areas included in the 2b region Region 2b as 1. As a result, the EDA tool 122 may generate a second array Array 2 capable of distinguishing a routable region from a non-routable region in the layout by using the components of the array. In some example embodiments, components corresponding to the routable region in the second array Array 2 may be represented as “0:, and components corresponding to the non-routable region may be represented as 1”, but are not limited thereto, and to distinguish between both regions, the components of any array may be represented by various characters.

In some example embodiments, as described above with reference to FIG. 6, the EDA tool 122 may receive location data on a third point C and a fourth point D specified externally, for example, by the user or the like. The EDA tool 122 may specify two points on the second array Array 2 as illustrated, based on the position data on the third point C and the fourth point D. Next, the EDA tool 122 may search for a path such as a sufficiently short path such as the shortest path (for example, a second shortest path SP2) connecting the specified third point C to fourth point D on the routable region Region 1b, for example, on the components represented as 0 in the second array Array 2. For example, either or both of the A* algorithm or a jump point search algorithm, which are algorithms for the shortest path search, may be used. However, inventive concepts are not limited thereto. For example, in addition to the algorithms described above, various methods may be used to search for the shortest path. In some example embodiments, the third point C and the fourth point D may include arbitrary positions of cells which are designated by a user to verify a path between arranged cells (or, designated by a user to specify desired positions of cells to be connected to each other). Hereinafter, duplicate descriptions thereof are omitted.

In this manner, inventive concepts may determine a routable region of a circuit by searching for the shortest path by using only physical information without logical information, that is, by converting initial level data into an array such as a 0-1 matrix such as a rectangular or square matrix having 0-1 components. A process of determining and verifying at an early stage whether cells, ports, or the like are arranged within distances desired by a user by using an array conversion and target operations are performed may be more automated, and the accuracy thereof may be improved by using an accurate area division. Thus, by promptly and accurately identifying points, where design rule violation and/or timing violation occur, required time and resources may be reduced, and TAT and/or QoR may be effectively improved.

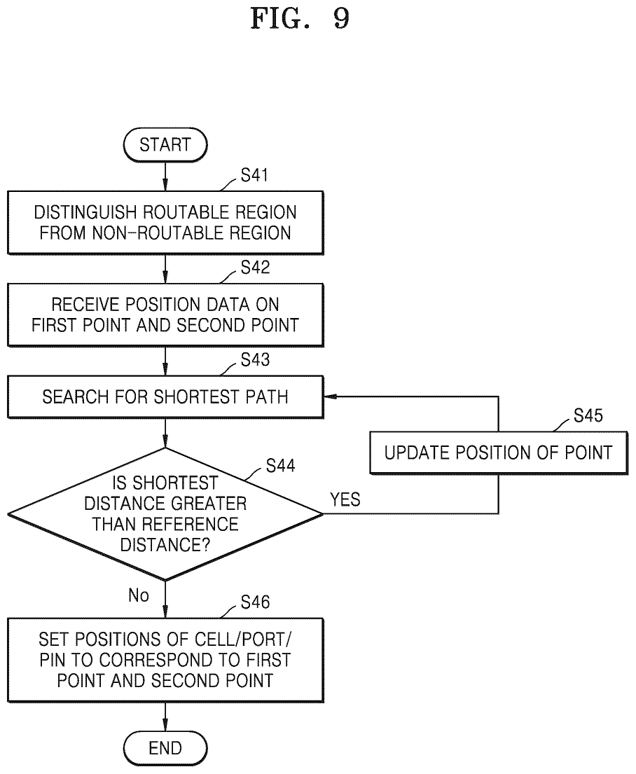

FIG. 9 is a flowchart of an integrated circuit layout design process according to some example embodiments.

Referring to FIGS. 3 and 9, the EDA tool 122 may design a layout by comparing the found distance of the shortest path with a reference distance. In FIG. 9, because operations S41 through S43 respectively correspond to operations S22 through S24 described above with reference to FIG. 3, descriptions thereof are omitted.

The EDA tool 122 may compare the searched distance of the shortest path (hereinafter, the shortest distance) with a reference distance (S44). The reference distance may be set or preset by an external control, such as a user. When the shortest distance is greater than the reference distance, because this indicates that the criteria such as the user's desired timing specification is not satisfied, the EDA tool 122 may receive position information about new point(s). For example, when the user specifies the first point A and the second point B and searches for the shortest path and as a result, the shortest distance is greater than the reference distance and does not meet a particular criterion, the user may specify a new point and search for the shortest path again. The user may designate new points to replace both the first point A and the second point B, or may also designate one point to replace any one of the first point A and the second point B. The EDA tool 122 may update position information about the points with position information about the new point(s) (S45).

On the contrary, when the shortest distance is less than or equal to the reference distance, the corresponding shortest path may be considered to satisfy a standard, such as the timing specification desired by the user. Accordingly, the EDA tool 122 may place cells (or one or more of ports, pins, or the like) to correspond to the first point A and the second point B, or may modify the positions of the cells (or one or more of ports, pins, etc.) (S46). For example, when the cells are to be placed, the EDA tool 122 may set each of the cells to be positioned at the first point A and the second point B so that cells are routed along the found shortest path. In this manner, the EDA tool 122 may repeat the shortest path search until the user desired conditions are satisfied.

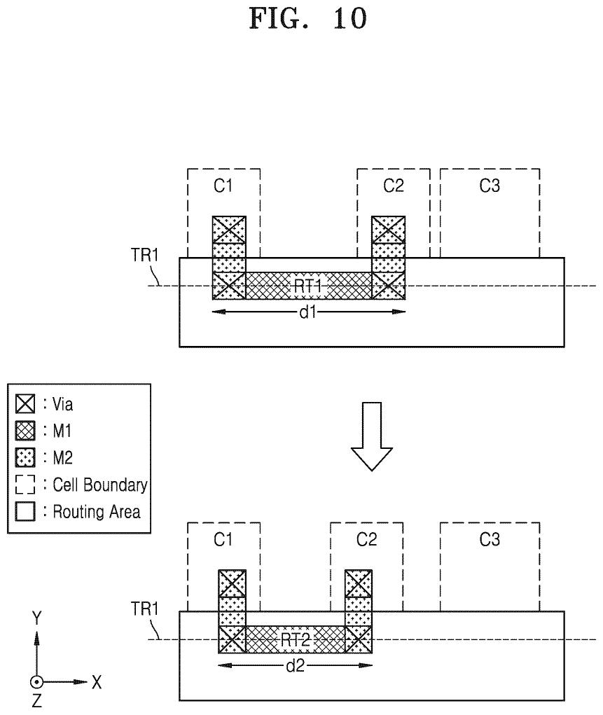

FIG. 10 is a diagram describing cell arrangement adjustment for the shortest path search operation, according to some example embodiments.

Referring to FIG. 10, in some example embodiments, the integrated circuit may include first through third cells C1 through C3. In addition, the integrated circuit may include a routing area. The routing area may include routing wirings connecting the first through third cells C1 through C3 to each other. The first and second cells C1 and C2 may be connected to each other by a first routing wiring RT1. The first routing wiring RT1 may be arranged along a first track TR1, and the first routing wiring RT1 may be formed on an M1 wiring layer that is different from an M2 wiring layer. The length of the first routing wiring RT1 in the X-axis direction may be a first distance d1. The length in the Y-axis direction of a routing wiring, for example, the width thereof, may be determined based on the length in the X-axis direction of the routing wiring.

For example, as described above, the user may request that the distance of the path formed when routing the first cell C1 and the second cell C2 is less than or equal to a first reference distance (a value less than the first distance d1 and greater than or equal to a second distance d2), so as to satisfy arbitrary specification (for example, timing delay, TAT, etc.). Because the first distance d1 of the first routing wiring RT1 is greater than the first reference distance, the user may designate at least one new point where the first cell C1 and the second cell C2 are to be positioned. A second routing wiring RT2 may be searched for, based on the result of searching for the shortest path between the new point(s) by the EDA tool 122. Because the second routing wiring RT2 has the second distance d2 in the X-axis direction and the second distance d2 is less than or equal to the first reference distance, the second routing wiring RT2 may satisfy the arbitrary specification. As a result, when a cell arrangement does not satisfy the arbitrary or specific requirement of the user, the cell arrangement may be modified based on the shortest path search operation of the EDA tool 122.

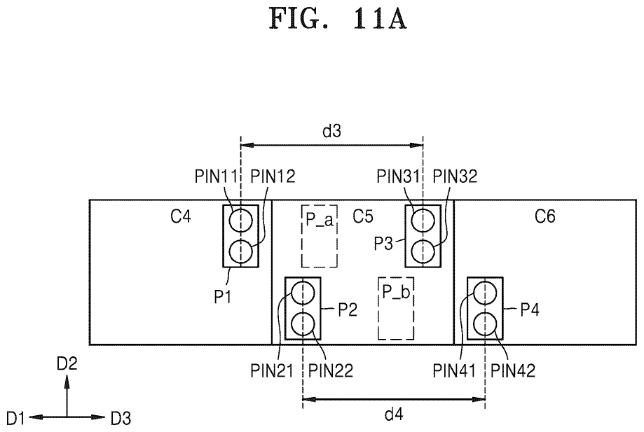

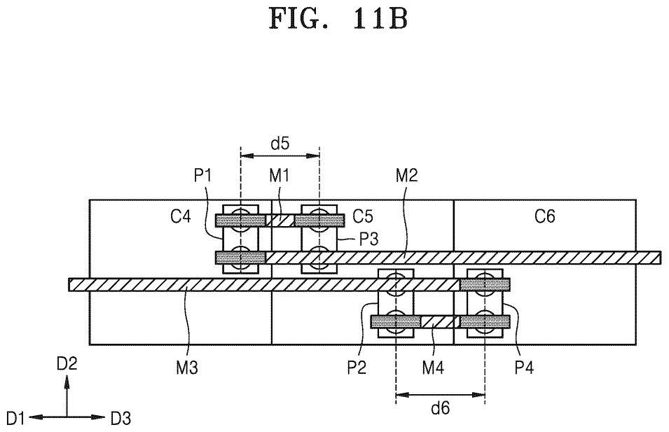

FIGS. 11A and 11B are diagrams describing port arrangement adjustment for the shortest path search operation, according to various example embodiments.

Referring to FIGS. 11A and 11B, in some example embodiments, the integrated circuit may include fourth through sixth cells C4 through C6, and each of the fourth through sixth cells C4 through C6 may be arranged adjacent to each other in a D3 direction. The fourth cell C4 may include a port P1, and the port P1 may include candidate positions PIN11 and PIN12 of pins arranged in a direction D2. The fifth cell C5 may include ports P2 and P3, the port P2 may include candidate positions PIN21 and PIN22 of pins, and the port P3 may include candidate positions PIN31 and PIN32 of pins. The sixth cell C6 may include a port P4, and the port P4 may include candidate positions PIN41 and PIN42 of pins. In the present embodiment, ports including two candidate positions are described, but are not limited thereto. For example, each of the ports may include various number of candidate positions.

As illustrated, for example, to connect the fourth cell C4 to the fifth cell C5, the pin of the port P1 may be connected to the pin of port P3. In this case, the length of the wiring for connecting the port P1 to the port P3 in the direction D3 may be a third distance d3. In addition, the pin of the port P2 may be connected to the pin of the port P4 to connect the fifth cell C5 to the sixth cell C6, and in this case, the length in the direction D3 of the wiring for connecting the port P2 to the port P4 may be a fourth distance d4. To satisfy the arbitrary specifications required by the user as described above, a second reference distance (a value less than the third distance d3 and greater than or equal to a fifth distance d5) and a third reference distance (a value less than the fourth distance d4 and greater than or equal to a sixth distance d6) may be set. Because the third distance d3 and the fourth distance d4 are respectively greater than the second reference distance and the third reference distance, the user may designate new point(s) at which the first through fourth ports P1 through P4 are positioned.

For example, the user may specify a point P_a as a new point of the port P3 and a point P_b as a new point of the port P2. Based on this specifying operation, the EDA tool 122 may search for the shortest path between new points (between the port P1 and the point P_a/between the point P_b and the port P4). As a result of the search, because the fifth distance d5 between the port P1 and the point P_a is less than or equal to the second reference distance and the sixth distance d6 between the point P_b and the point P4 is less than or equal to the third reference distance, the arbitrary specifications may be satisfied. Accordingly, the positions of the ports P2 and P3 may be adjusted based on the above results, and the ports P1 and P3 may be routed to the wiring M1, and the ports P2 and P4 may be routed to the wiring M4, along the found shortest path. Similarly, the candidate position PIN12 of the pin of the port P1 may be routed to the wiring M2 in the D3 direction to satisfy the shortest path with respect to other cells, and the candidate position PIN41 of the pin of the port P4 may also be routed to the wiring M3 in the direction D1 to satisfy the shortest path with respect to other cells.

As a result, when a port arrangement does not satisfy arbitrary requirements of the user, the port arrangement may be modified based on the shortest path search operation of the EDA tool 122.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While inventive concepts has been particularly shown and described with reference to embodiments thereof, it will be understood that various changes in form and details may be made therein without departing from the spirit and scope of the following claims. Additionally example embodiments are not necessarily mutually exclusive with one another. For example, some example embodiments may include one or more features described with reference to one or more figures, and may also include one or more other features described with reference to one or more other figures.

What is claimed is:

1. A method of designing a layout of an integrated circuit, the method comprising:
generating floorplan data by performing a floorplan operation based on input data for the integrated circuit;
searching for a path between a first point and a second point, which are specified, based on the floorplan data; and
positioning components of the layout based on a result of the searching,
wherein the searching for the path comprises,
distinguishing a first region, where routing is possible, from a second region, where the routing is not possible, the distinguishing based on the floorplan data,
receiving position data on the first point and the second point, and
searching for a shortest path between the first point and the second point, in the first region.

2. The method of claim 1, wherein the distinguishing of the first region from the second region comprises:
generating an array including components, each of the components corresponding to a unit area, the generating based on the floorplan data; and
distinguishing the first region from the second region based on the array.

3. The method of claim 2, wherein the unit area is set by an external control.

4. The method of claim 2, wherein the distinguishing of the first region from the second region comprises, in the array, representing the components of the array corresponding to the first region and the components of the array corresponding to the second region with different characters.

5. The method of claim 1, wherein the searching for the path further comprises determining whether to search again for a path between points by comparing a distance of the shortest path with a reference distance.

6. The method of claim 5, wherein the determining of whether to search again comprises, in response to the distance of the shortest path being greater than the reference distance, receiving position data on at least one new point replacing at least one of the first point and the second point and searching for a new shortest path between two points.

7. The method of claim 5, wherein the positioning of the components of the layout comprises, in response to the distance of the shortest path being less than or equal to the reference distance connecting cells along the shortest path by arranging the cells to correspond to the first point and the second point.

8. The method of claim 5, wherein the positioning of the components of the layout comprises, in response to the distance of the shortest path being less than or equal to the reference distance, setting positions of ports included in cells to correspond to the first point and the second point.

9. The method of claim 5, wherein the reference distance is set by an external control.

10. The method of claim 1, wherein the searching for the shortest path comprises searching for a shortest path between the first point and the second point by using at least one of an a-star (A*) algorithm or a jump point search algorithm.

11. A method of designing a layout of an integrated circuit, the method comprising:
receiving physical data including physical information about the integrated circuit, for input data on the integrated circuit;
distinguishing a first region, where routing is possible, from a second region, where the routing is not possible, based on the physical data;
receiving position information about a first point and a second point, which are specified; and
searching for a shortest path between the first point and the second point, in the first region.

12. The method of claim 11, wherein the physical data comprises design exchange format (DEF) data and library exchange format (LEF) data.

13. The method of claim 11, wherein the distinguishing of the first region from the second region comprises:
dividing the layout by a unit area;
converting the layout into an array including components, each of the components corresponding to the unit area; and
representing the components of the array corresponding to the first region and the components of the array corresponding to the second region with different characters.

14. The method of claim 11, further comprising:
determining whether to search again for a path between points by comparing a distance of the shortest path with a reference distance.

15. The method of claim 14, wherein the determining of whether to search again comprises, in response to the distance of the shortest path being greater than the reference distance, receiving position information about at least one new point replacing at least one of the first point and the second points, and searching for a new shortest path between two points.

16. The method of claim 14, further comprising, in response to the distance of the shortest path being less than or equal to the reference distance, connecting cells along the shortest path by arranging the cells to correspond to the first point and the second point, or by setting positions of ports included in the cells.

17. The method of claim 11, wherein the searching for the shortest path comprises searching for a shortest path between the first point and the second point by using at least one of an a-star (A*) algorithm or a jump point search algorithm.

18. A system configured to design a semiconductor chip, the system comprising:
a processor; and
a memory connected to the processor and storing machine-readable commands that, when executed by the processor, cause the system to perform a wiring path search operation for designing the semiconductor chip,
wherein, by using the commands, the processor is configured to,
receive physical information about design exchange format (DEF) data of the semiconductor chip and to receive physical information about library exchange format (LEF) data of the semiconductor chip,
based on the physical information, distinguish a first region, where routing is possible, from a second region, where the routing is impossible in the semiconductor chip,
generate an array having a size corresponding to a size of the semiconductor chip,
represent a first component group including components of the array corresponding to the first region and a second component group including components of the array corresponding to the second region,
receive position information about a first point and a second point, which are specified, and
search for a shortest path between the first point and the second point in the first component group.

19. The system of claim 18, wherein the processor, in response to the distance of the shortest path being greater than a reference distance, is configured to receive position information about at least one new point(replacing at least one of the first point and the second point, and searches for a new shortest path between two points.

20. The system of claim 18, wherein the processor, in response to the distance of the shortest path being less than or equal to a reference distance, is configured to arrange at least one of cell to correspond to the first point and the second point,
or set position of at least one of port comprised in cells to correspond to the first point and the second point, to connect cells along the shortest path.
